(19) United States
(12) Patent Application Publication
(10) Pub. No.: US 2018/0059220 A1
(43) Pub. Date: Mar. 1, 2018

(54) LASER RANGING DEVICE WITH BEAM SIGNATURE AND SIGNATURE RECOGNITION

(71) Applicant: QUALCOMM Incorporated, San Diego, CA (US)

(72) Inventors: Linda Irish, San Diego, CA (US); William Henry Von Novak, San Diego, CA (US)

(21) Appl. No.: 15/251,958

(22) Filed: Aug. 30, 2016

(51) Int. Cl. G01S 7/481; G01S 17/10

(52) U.S. Cl. CPC G01S 7/4814; G01S 7/4816; G01S 17/10

(57) ABSTRACT

Techniques provided herein are directed toward enabling a laser ranging device to include, in optical pulses it generates, one or more unique “signatures” that enable the laser ranging device to distinguish pulses it generates from pulses generated by other laser ranging devices. These “signatures” can include a ringing frequency generated by residence circuitry in a laser driver of the laser ranging device that includes an adjustable capacitor enabling adjustment of the ringing frequency. Circuitry in the laser ranging device receiver can process a signal made by a detected pulse to determine whether a signature of the detected pulse substantially matches a signature of a transmitted pulse.

### BACKGROUND

Light Detection And Ranging (LIDAR) is a surveying technology that measures distance by illuminating a target with a laser light, reading a pulse corresponding to the reflected laser light, and determining the length of time it took for light to travel between the LIDAR system and the target. LIDAR is often utilized to determine the topology of a landscape, and LIDAR is commonly used in modern vehicles to help determine distances between the vehicles and objects in their surroundings. However, because LIDAR is becoming more ubiquitous, there is an increased likelihood that LIDAR systems will interfere with one another.

### SUMMARY

Techniques provided herein are directed toward enabling a laser ranging device (e.g., a LIDAR system, or the like) to include, in optical pulses it generates, one or more unique “signatures” that enable the laser ranging device to distinguish pulses it generates from laser pulses/reflections associated with other systems/devices. These “signatures” can include a ringing frequency generated by residence circuitry in a laser driver of the laser ranging device that includes an adjustable capacitor enabling adjustment of the ringing frequency. Circuitry in the laser ranging device receiver can process a signal made by a detected pulse to determine whether a signature of the detected pulse substantially matches a signature of a transmitted pulse.

An example laser ranging device, according to the disclosure, comprises a laser and resonance components including an inductive element and a capacitive element having an adjustable capacitance. The laser ranging device may be configured to cause the laser to generate a pulse with a ringing frequency, where the ringing frequency may be determined by an inductance of the inductive element and a capacitance of the capacitive element.

Embodiments of the laser ranging device may include one or more of the following features. The laser ranging device may comprise control circuitry configured to adjust the capacitance of the capacitive element. The control circuitry may be configured to adjust the capacitance of the capacitive element to a unique value for each transmitted laser pulse in a series of transmitted laser pulses, such that each transmitted laser pulse has a unique ringing frequency. The control circuitry may be configured to adjust the capacitance of the capacitive element to a pseudo-random value for each transmitted laser pulse in the series of transmitted laser pulses. The control circuitry may be configured to adjust the capacitance of the capacitive element in response to receiving an indication that a detected pulse has a substantially similar ringing frequency and was not generated by the laser ranging device. The inductive element and the capacitive element may be coupled in series or coupled in parallel. The ringing frequency may comprise a frequency between 100 MHz and 1 GHz. The laser ranging device may further comprise laser receiver circuitry, the laser receiver circuitry including one or more light sensors configured to receive a detected laser pulse, an amplification circuit coupled to an output of the one or more light sensors, and a capacitive element coupled to an output of the amplification circuit. The laser receiver circuitry may further include an analog-to-digital converter (ADC) configured to receive an analog signal from the capacitive element and provide a digital output; and processing circuitry configured to receive the digital output of the ADC and provide an indication of whether the detected laser pulse includes the ringing frequency of the pulse generated by the laser. The laser receiver circuitry may further include a comparator circuit configured to receive an analog signal from the capacitive element provide an indication that the detected laser pulse was detected, and processing circuitry configured to receive the analog signal from the capacitive element and provide an indication of whether the detected laser pulse includes the ringing frequency of the pulse generated by the laser. The processing circuitry may be configured to provide the indication of whether the detected light pulse includes the ringing frequency by providing an indication of a degree to which a frequency detected in the detected laser pulse matches the ringing frequency of the pulse generated by the laser.

An example method of generating laser pulses in a laser ranging device, according to the disclosure, comprises, in a laser driver circuit with resonance circuitry comprising a capacitive element with an adjustable capacitance and an inductive element, adjusting a capacitance of the capacitive element; and using the laser driver circuit to cause a laser to generate a pulse with a ringing frequency, wherein the ringing frequency may be determined by an inductance of the inductive element and the capacitance of the capacitive element.

The method of generating laser pulses in a laser ranging device may include one or more of the following features. The method may further comprise using control circuitry to adjust the capacitance of the capacitive element. The method may further comprise adjusting the capacitance of the capacitive element to a unique value for each transmitted laser pulse in a series of transmitted laser pulses, such that each transmitted laser pulse has a unique ringing frequency. The method may further comprise adjusting the capacitance of the capacitive element to a pseudo-random value for each transmitted laser pulse in the series of transmitted laser pulses. The method may further comprise adjusting the capacitance of the capacitive element in response to receiving an indication that a detected pulse has a substantially similar ringing frequency and was not generated by the laser ranging device. The ringing frequency may comprise a frequency between 100 MHz and 1 GHz. The method may further comprise receiving a detected laser pulse, amplifying an output generated from the received detected laser pulse, and modifying the amplified output with a capacitive element. The method may further comprise converting an analog output of the capacitive element to provide a digital output, and providing an indication of whether the detected laser pulse includes the ringing frequency of the pulse generated by the laser, wherein the indication is based on the digital output. The method may further comprise using a comparator circuit to receive an analog signal from the capacitive element and provide an indication that the detected laser pulse was detected, and providing an indication of whether the detected laser pulse includes the ringing frequency of the pulse generated by the laser. The method may further comprise providing the indication of whether the detected light pulse includes the ringing frequency by providing an indication of a degree to which a frequency detected in the detected laser pulse matches the ringing frequency of the pulse generated by the laser.

An example apparatus for generating laser pulses in a laser ranging device, according to the disclosure, comprises, in a laser driver circuit with resonance circuitry comprising a capacitive element with an adjustable capacitance and an inductive element, means for adjusting a capacitance of the capacitive element, and means for using the laser driver circuit to cause a laser to generate a pulse with a ringing frequency, wherein the ringing frequency is determined by an inductance of the inductive element and the capacitance of the capacitive element.

The apparatus may include one or more of the following features. The apparatus may include means for using control circuitry to adjust the capacitance of the capacitive element. The apparatus may include means for adjusting the capacitance of the capacitive element to a unique value for each transmitted laser pulse in a series of transmitted laser pulses, such that each transmitted laser pulse has a unique ringing frequency. The apparatus may include means for adjusting the capacitance of the capacitive element to a pseudo-random value for each transmitted laser pulse in the series of transmitted laser pulses. The apparatus may include means for adjusting the capacitance of the capacitive element in response to receiving an indication that a detected pulse has a substantially similar ringing frequency and was not generated by the laser ranging device. The ringing frequency may comprise a frequency between 100 MHz and 1 GHz. The apparatus may include means for receiving a detected laser pulse, means for amplifying an output generated from the received detected laser pulse, and means for modifying the amplified output with a capacitive element. The apparatus may include means for converting an analog output of the capacitive element to provide a digital output, and means for providing an indication of whether the detected laser pulse includes the ringing frequency of the pulse generated by the laser, wherein the indication is based on the digital output. The apparatus may include means using a comparator circuit to receive an analog signal from the capacitive element and provide an indication that the detected laser pulse was detected, and means for providing an indication of whether the detected laser pulse includes the ringing frequency of the pulse generated by the laser. The means for providing the indication of whether the detected light pulse includes the ringing frequency comprise means for providing an indication of a degree to which a frequency detected in the detected laser pulse matches the ringing frequency of the pulse generated by the laser.

### BRIEF DESCRIPTION OF THE DRAWINGS

An understanding of the nature and advantages of various embodiments may be realized by reference to the following figures.

FIG. 1 is a simplified block diagram of a laser ranging device that can utilize the techniques discussed herein, according to one embodiment.

FIG. 2 is a schematic diagram of a laser driver circuit utilized in laser ranging devices, according to one embodiment.

FIG. 3 is a graph that illustrates an example laser pulse generated by the laser driver circuit of FIG. 2.

FIGS. 4A and 4B are schematic diagrams of embodiments of laser driver circuits.

FIG. 5 is a graph that illustrates an example laser pulses and generated in accordance with techniques provided herein, which may be produced by the laser driver circuits of FIGS. 4A or 4B.

FIG. 6 is a schematic diagram of a basic receiving circuit, according to embodiments.

FIGS. 7A and 7B are block diagrams of a processing circuits, according to different embodiments.

FIG. 8 is a flow diagram of a method of generating laser pulses in a laser ranging device, according to one embodiment.

FIG. 9 is a flow diagram of a method of receiving and optionally decoding laser pulses in a laser ranging device, according to some embodiments.

### DETAILED DESCRIPTION

The ensuing description provides embodiment(s) only, and is not intended to limit the scope, applicability or configuration of the disclosure. Rather, the ensuing description of the embodiment(s) will provide those skilled in the art with an enabling description for implementing an embodiment. It is understood that various changes may be made in the function and arrangement of elements without departing from the spirit and scope of this disclosure.

LIDAR is a surveying technology that measures distance by illuminating a target with a laser light (e.g., one or more laser beams from a LIDAR transmitter) and reading a pulse corresponding to the reflected laser light. LIDAR is often utilized to determine the topology of a landscape, and LIDAR is commonly used in modern vehicles (e.g., to implement self-driving and/or other features) to help determine distances between the vehicles and objects in their surroundings. The techniques presented herein may be implemented in various apparatuses which may are referred to herein simply as laser ranging devices or systems. One non-limiting example of one possible type of laser ranging device or system is a LIDAR device or system. Thus, it should be understood that, although the recognizable term LIDAR is used herein, the techniques may be applied to laser ranging devices or systems that may or may not be considered to be identified as LIDAR devices or system by some definitions.

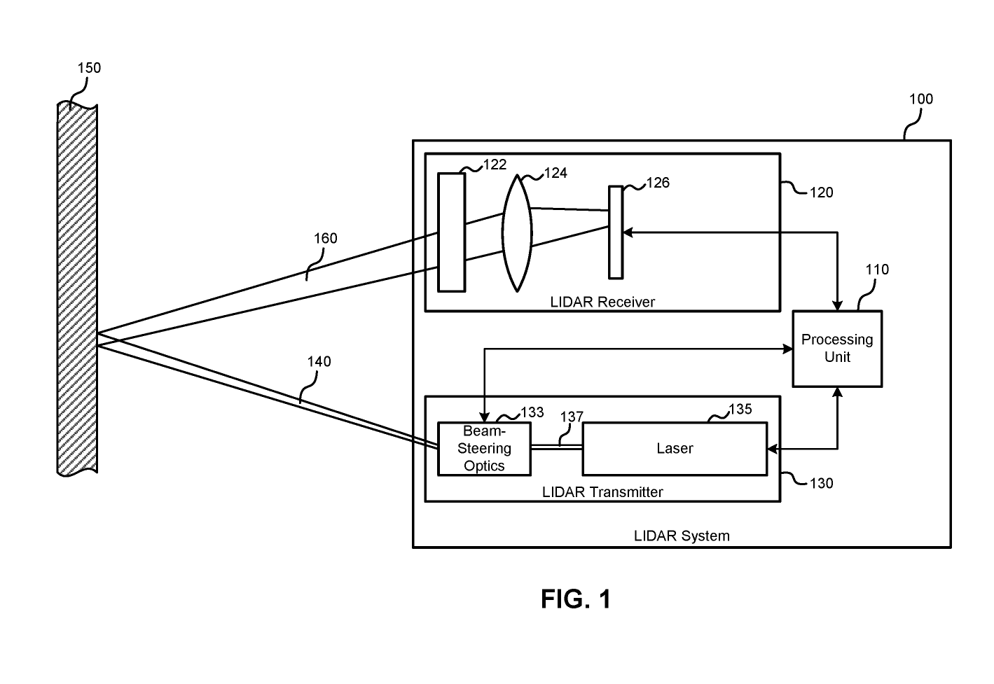

FIG. 1 is a simplified block diagram of an embodiment of an example laser ranging device or system in the form of a LIDAR system 100, provided here to illustrate the basic functionality of the LIDAR system 100. As illustrated, a LIDAR system 100 can comprise a LIDAR transmitter 130 (which includes a laser 135 and beam-steering optics 133), a LIDAR receiver 120 (which includes filtering optics 122, focusing optics 124, and a sensor 126), and a processing unit 110. A person of ordinary skill in the art will recognize that alternative embodiments of a LIDAR system 100 may include additional or alternative components to those shown in FIG. 1. For example, components may be added, removed, combined, or separated, depending on desired functionality, manufacturing concerns, and/or other factors. In some embodiments, for example, the LIDAR receiver and the LIDAR transmitter may have separate processing units or other circuitry controlling the operation thereof.

In general, the operation of the LIDAR system 100 is as follows. The processing unit 110 causes the laser 135 to generate a laser beam 137 that is fed to the beam-steering optics. The beam-steering optics 133 adjusts the direction and/or spot size of the laser beam 137 (using, for example, a Risley prism pair, micro electromechanical systems (MEMS) reflectors, and/or other means) to create a transmitted laser beam 140 that scans a field of view (FOV) of the LIDAR system 100. In so doing, the transmitted laser beam 140 reflects off an object 150 within the FOV, creating a reflected laser beam 160 that is detected by the LIDAR receiver 120. The filtering optics 122 can be used to filter out unwanted light (e.g., wavelength of light other than the wavelength(s) generated by the laser 135), and the focusing optics 124 can be used to project to the reflected laser beam 160 onto a light-sensing surface of the sensor 126. The sensor 126 can then provide information to the processing unit 110 that enables the processing unit 110 to determine a distance of the object. Distance is measured by the time it takes for the light to be reflected back to the LIDAR system 100. As the beam-steering optics 133 scans the entire FOV of the LIDAR system 100, reflected laser light is received by the LIDAR receiver, and the processing unit 110 is able to determine the distance of many objects within the entire FOV of the LIDAR system 100.

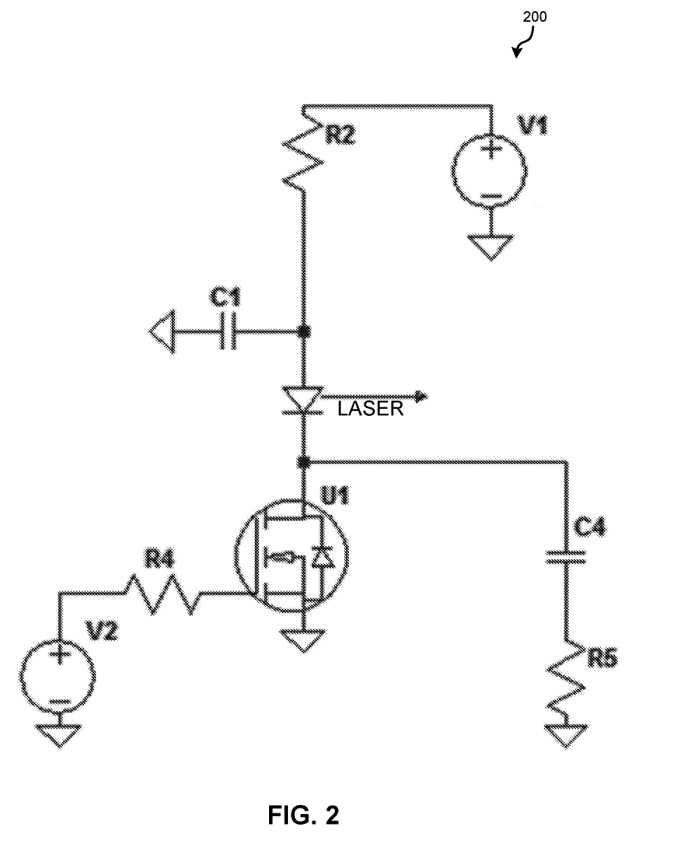

The transmitted laser beam 140 is generally pulsed (rather than continuous) to facilitate the determination of a distance between the LIDAR system 100 and objects within its FOV. An example circuit for generating the pulse is provided in FIG. 2 and described in more detail below. The LIDAR transmitter 130 will send out a series of laser pulses as it scans its FOV. For each laser pulse, having a sharp rise time helps the LIDAR system 100 measure distances with high resolutions. Currently, LIDAR systems are capable of measuring distances with resolutions of less than 1 foot.

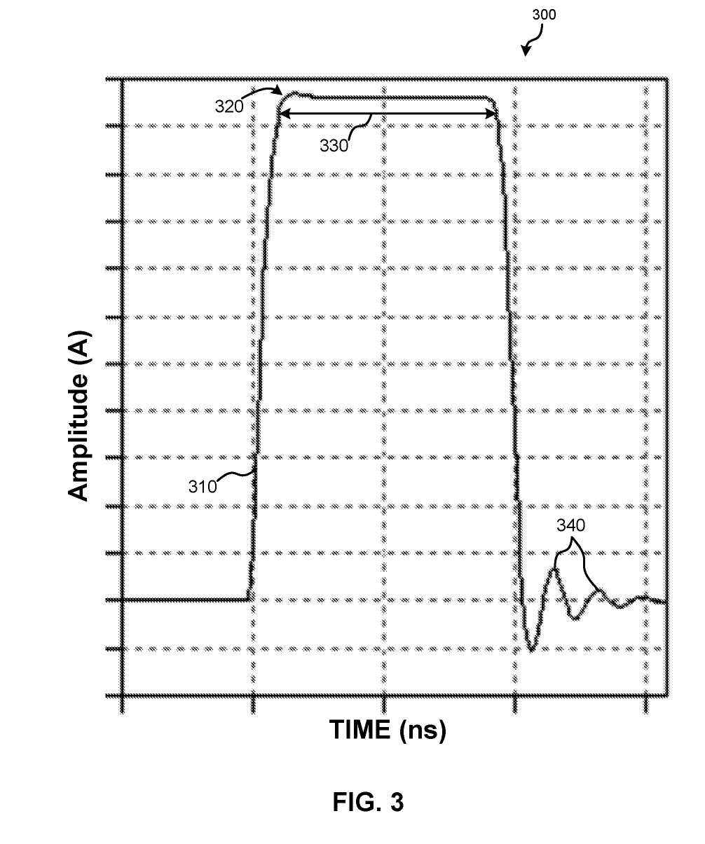

FIG. 2 is a schematic diagram of a laser driver circuit 200 utilized in LIDAR systems, according to one embodiment. The laser driver circuit 200 could, for example, be incorporated into the laser 135, processing unit 110, and/or intervening circuitry (not illustrated in FIG. 1) and configured to cause the laser 135 to generate a laser beam 137 comprising a laser pulse (such as the laser pulses illustrated in FIG. 3, discussed in more detail below). In one embodiment, the laser illustrated in FIG. 2, may comprise the laser 135 of FIG. 1, and voltage V2 to the input of transistor U1 illustrated in FIG. 2 (used to cause the laser driver circuit 200 to generate a laser pulse) may be a pulsed signal and may be provided by the processing unit 110.

The laser driver circuit 200 comprises a current-limiting resistor R2 that sets laser current through the duration of the pulse. The capacitor C1 helps speed up the laser turn on by charging to the supply voltage and allowing for a small energy storage as the transistor U1 (which, in some embodiments, is a GaNFET) turns on. If C1 is too large, the current in the laser may overshoot during turn on. If C1 is too small, the rise time of the laser current will be slower than desired.

At the turn off of the laser, there is a little bit of ringing in the laser current that causes “runt” pulses at the end of the pulse. A Snubber network comprising capacitor C4 and resistor R5 can be used to reduce the amount of ringing. Although the runt pulses are normally not desired, they also do not do any harm since they come after the leading edge of the pulse (which is the edge of the pulse used in distant measurements). These runt pulses are close enough behind the primary pulse that they do not interfere with pulse detection and do not occupy significant time within the timeslot for the laser.

Values for the laser driver circuit 200 components illustrated in FIG. 2 can vary depending on desired functionality, manufacturing concerns, and/or other factors. In one embodiment, for example, values for resistors R2, R4, and R5 are 3, 2, and 10 ohms respectively; values for C1 and C4 are 82 pF and 33 pF, respectively; and V1 is 45 V. These are, of course, example values, and other embodiments may have values greater or smaller than those provided here.

FIG. 3 is a graph 300 that illustrates a computer simulation representative of an example laser pulse generated by the laser driver circuit 200, showing amplitude (in amps) as a function of time (in nanoseconds (ns)). Here, the width 330 of the pulse is approximately 10 ns. The rise time of the leading edge 310 is approximately 1 ns, and there is a slight overshoot 320 during turn on. Turn off (which is also approximately 1 ns) results in ringing, with corresponding runt pulses 340. It will be understood that the features of the laser pulse (such as amplitude, rise time, width, etc.) may vary, according to desired functionality, manufacturing concerns, and/or other factors.

LIDAR systems, such as the LIDAR system 100 of FIG. 1, are becoming increasingly popular, partially due to the fact that an increasing number of cars use LIDAR systems. This increases the likelihood of interference between LIDAR systems. That is, there is an increased likelihood that that a LIDAR system 100 will detect a laser pulse generated by another LIDAR system. If the LIDAR system 100 that detects the laser pulse is unable to distinguish the laser pulse from laser pulses transmitted by its own LIDAR transmitter 130, it can negatively impact the operation of the LIDAR system 100.

Techniques described herein below enable a LIDAR system to become more robust by adding a “signature” to the outgoing transmitted laser pulses so that the LIDAR system can, when it receives a laser pulse, distinguish its laser pulses from the laser pulses of other LIDAR systems. Embodiments involve modulating current to the laser at high frequencies during the laser pulse by tailoring the “ring” frequencies to each pulse. If each laser has a characteristic “ring” frequency, it can be uniquely identified in the presence of other such pulses. The runt pulses after the laser firing can be deliberately created and changed to make the pulses more unique, adding to the signature. With the addition of tunable resonant components, the signature can be changed on the fly with the use of passive components. Embodiments are provided in detail below.

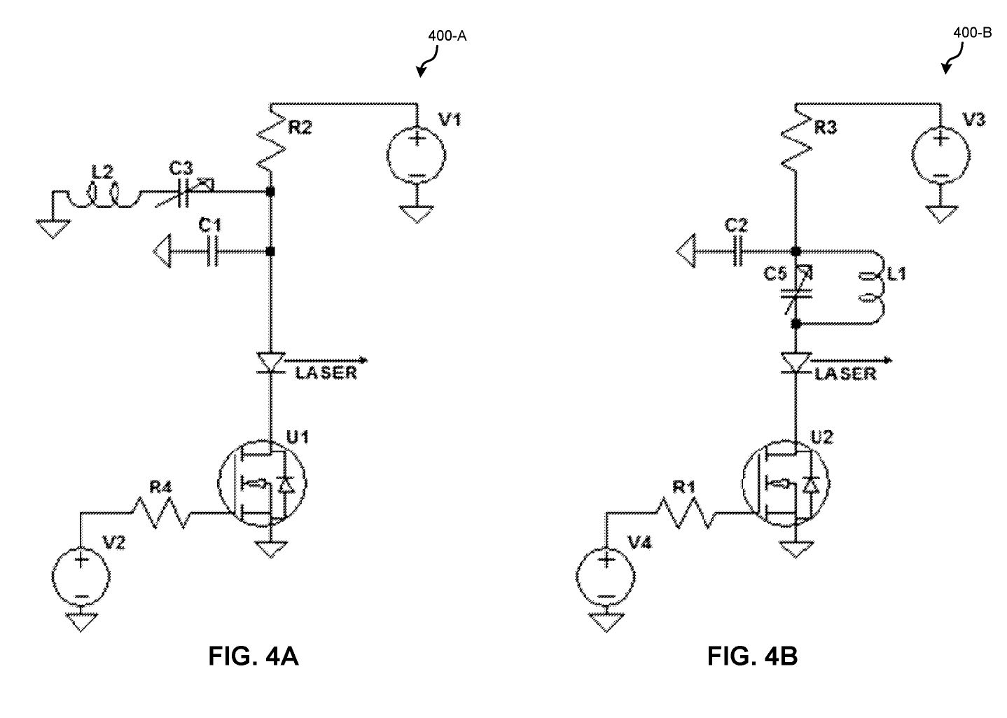

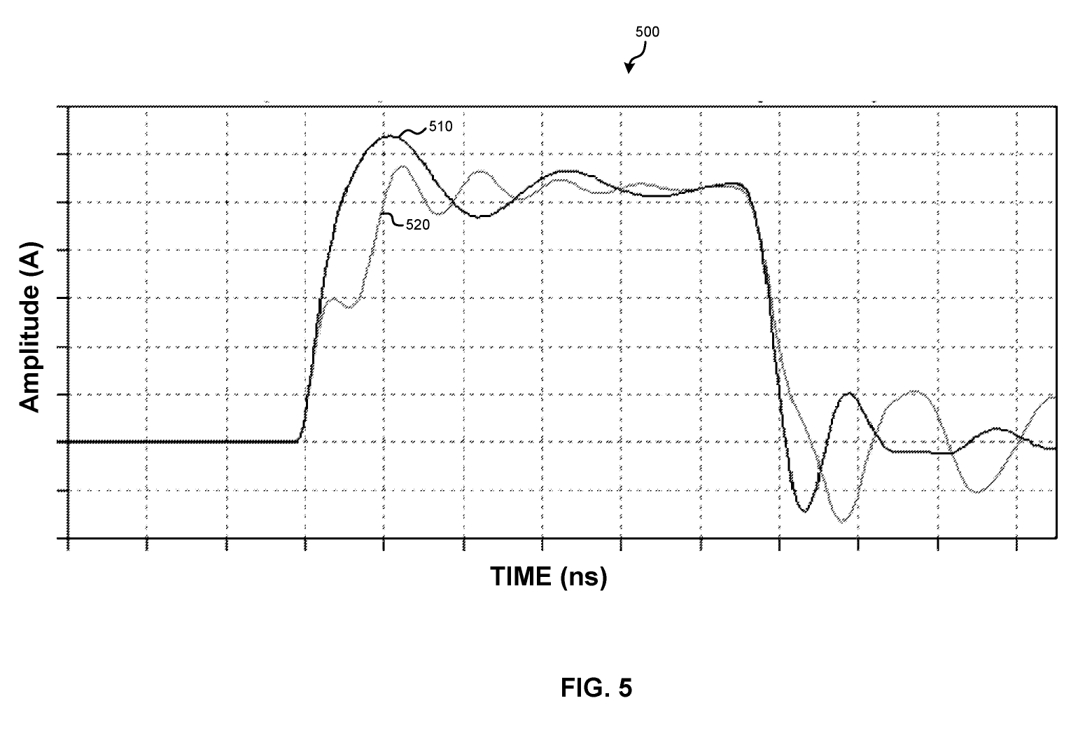

FIGS. 4A and 4B are schematic diagrams of laser driver circuits 400-A and 400-B, respectively, illustrating two different embodiments of laser driver circuitry that can be utilized according to techniques provided herein. Either of these circuits can be utilized in LIDAR systems, such as the LIDAR system 100 of FIG. 1, in approximately the same manner as the laser driver circuit 200 of FIG. 2. That is, laser driver circuits 400-A and 400-B could be incorporated into the laser 135, processing unit 110, and/or intervening circuitry (not shown in FIG. 1) and configured to cause the laser 135 to generate a laser beam 137 comprising a laser pulse (such as the laser pulses illustrated in FIG. 5, discussed in more detail below).

Laser driver circuits 400-A and 400-B are generally configured to provide a ringing frequency and/or runt pulses that can be used to identify laser pulses generated by the LIDAR system. To do so, laser driver circuits 400-A and 400-B omit the Snubber network (capacitor C4 and resistor R5) shown in FIG. 2, which is used to reduce the amount of ringing. Instead, laser driver circuits 400-A and 400-B utilize a tunable resonant network that is used to provide an identifiable ringing frequency on each laser pulse. In laser driver circuit 400-A, the tunable resonant network comprises inductor L2 and adjustable capacitor C3, which are connected in series. In laser driver circuit 400-B, the tunable resonant network comprises inductor L1 and adjustable capacitor C5. Because the values of capacitors C3 and C5 are adjustable, this enables the laser driver circuits 400-A and 400-B to provide a tunable ringing frequency on a generated laser pulse.

Values for components of the laser driver circuits 400-A and 400-B illustrated in FIGS. 4A and 4B can vary depending on desired functionality, manufacturing concerns, and/or other factors. Generally speaking, values for V1, V2, R1-R4, C1, and C2 can be similar to corresponding components illustrated in FIG. 2. In one embodiment of laser driver circuit 400-A, R2 and R4 are 3 and 2 ohms respectively; L2 is 4 nH; C1 is 82 pF; and V1 is 45 V. In one embodiment of laser driver circuit 400-B, values for R1 and R3 are 2 and 3 ohms respectively; L1 is 2 nH; C2 is 82 pF; and V3 is 45 V. Generally speaking, values of capacitance and inductance can be chosen so the resonant frequency is the signature frequency. The values would also be chosen to optimize the amplitude of the signature. For a given pulsewidth, a likely range of resonant frequencies would be f=1/pulsewidth to f=10/pulsewidth, for example. These are, of course, example values, and other embodiments may have values or ranges of values greater or smaller than those provided here.

According to some embodiments, the value of capacitor C3 or C5 may be adjusted via an input voltage or current on a third terminal of the capacitor (not shown). Thus, the value of adjustable capacitor C3 or C5 may be set by a processing unit (e.g., processing unit 110) that drives the adjustable capacitor via a digital-to-analog converter (DAC). In some embodiments, the adjustable capacitor may comprise a metal oxide semiconductor (MOS) capacitor where one plate is similar to the gate of a MOS field emitting transistor (MOSFET), and the other plate is a variable-width plate where the width of the plate is changed by controlling the width of the depletion region. Additional details regarding this type of adjustable capacitor can be found in U.S. Pat. No. 9,401,436, which is incorporated by reference herein for all purposes. Other embodiments may employ other types of adjustable capacitors. In operation, the value of adjustable capacitor C3 or C5 may be adjusted to vary the ringing frequency of an outgoing laser pulse, as illustrated in FIG. 5.

FIG. 5 is a graph 500 that illustrates a computer simulation representative of an example laser pulses 510 and 520 generated in accordance with techniques provided herein. As with graph 300 of FIG. 3, graph 500 shows amplitude (in amps) as a function of time (in nanoseconds). For example, either or both of these pulses could be generated by laser driver circuit 400-A or 400-B of FIGS. 4A and 4B, respectively. Here, various features of laser pulses 510 and 520 such as amplitude, rise time, and with our similar to the pulse illustrated in FIG. 3. And as with FIG. 3, these features may vary depending on desired functionality. Here, however, first and second laser pulses, 510 and 520 respectively, include first and second ringing frequencies, which can create amplitude modulation of the laser pulses 510 and 520 and/or cause runt pulses.

As previously mentioned, the ringing frequency can be used as a signature to identify a pulse generated by the LIDAR system. If the ringing frequency of a pulse detected by the LIDAR system substantially matches the ringing frequency of the pulse generated by the LIDAR system, the LIDAR system can conclude that the detected pulse was generated by the LIDAR system and can use the detected pulse to implement LIDAR functionality (determine a distance to an object). In some embodiments, the ringing frequency is smaller than the width of the pulse. Therefore, for a 10 ns pulse, the ringing frequency can range from 100 MHz to approximately 1 GHz (or more). Other embodiments may have pulses and/or ringing frequencies with greater or smaller values, depending on desired functionality. In some embodiments, the ringing frequency can be chosen such that two or more cycles of the ringing frequency occur within the pulse width. (Values of the components of the adjustable resonant networks in the laser driver circuitry, e.g., laser driver circuit 400-A or 400-B, may therefore be chosen accordingly.) The upper limit of the ringing frequency can be governed by the driving circuitry and/or the detection circuitry (which, in some embodiments, may need to digitize the ringing frequency in order to detect it). Additional details regarding detection circuitry are provided below.

Operation of a LIDAR system that utilizes ringing frequencies in the manner described herein can vary, depending on desired functionality. In some embodiments, for example, a LIDAR system may adjust the ringing frequency of each generated pulse in a series of pulses such that the signature of each pulse in the series of pulses is different. The LIDAR system may further adjust the ringing frequency in a pseudo-random manner to reduce the likelihood that a series of pulses from another LIDAR system will be modulated with a ringing frequency in the same manner as a series of pulses generated by the LIDAR system. In some embodiments, the LIDAR system may maintain a static value for the ringing frequency (for example, by maintaining a static value for an adjustable capacitor in the LIDAR system's laser driver circuitry) unless the LIDAR system determines that pulses from another LIDAR system include a ringing frequency that is substantially similar to the ringing frequency of the LIDAR system. (Such a determination may be made by, for example, detecting a pulse that has substantially the same ringing frequency as a pulse generated by the LIDAR system but that does not correspond in time with the pulse generated by the LIDAR system.)

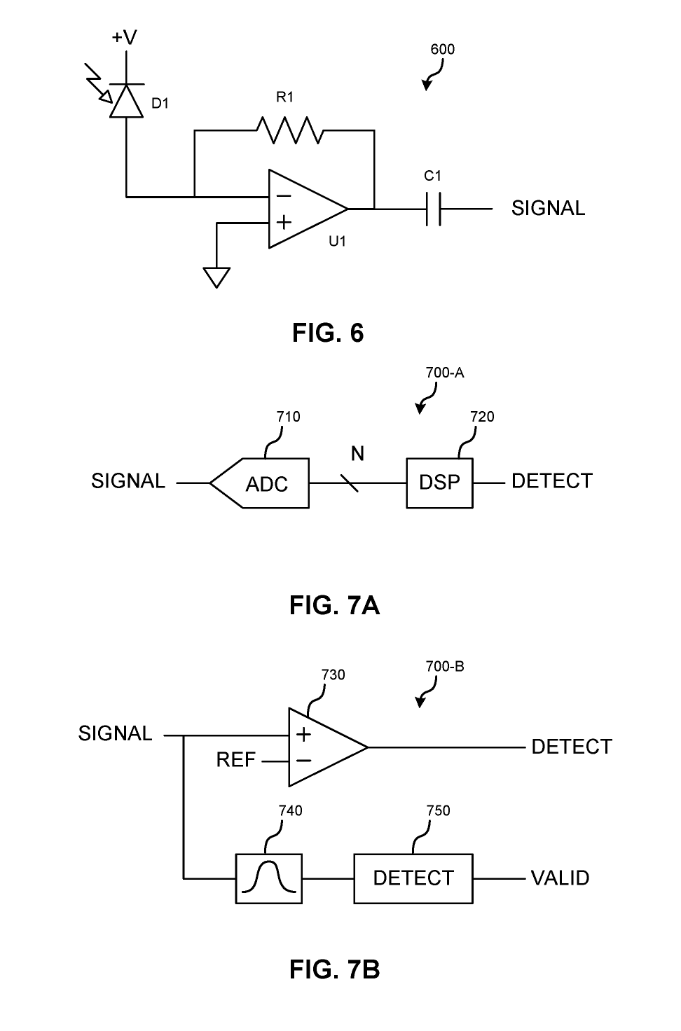

Because a LIDAR system typically generates pulses at a rate far slower (e.g., every 2 μs or longer) than the time it takes for a generated laser pulse to reflect off of an object in the LIDAR system's FOV and be detected by the LIDAR system (typically 300 ns or less), it can be relatively easy for the LIDAR system to correlate a transmitted laser pulse with a detected laser pulse. For example, when the LIDAR system detects a laser pulse, it can compare the detected laser pulse with the most recently-generated laser pulse to determine whether it has substantially the same ringing frequency. The relatively long period of time between generated pulses also provides the LIDAR system with time to make this determination. A LIDAR system may make this determination using any of a variety of hardware and/or software solutions. Some embodiments of such solutions are provided in FIGS. 6, 7A, and 7B, described in further detail below.

FIG. 6 is a schematic diagram of a basic receiving circuit 600, according to embodiments. As illustrated, the basic receiving circuit 600 can include a photodiode D1, a resistive element R1, a capacitive element C1, and an amplifier U1. The basic receiving circuit 600 generally operates by receiving an optical input at the photodiode D1 (which is configured to receive a bias voltage, +V) and provides a corresponding output (“SIGNAL”). More specifically, the photodiode D1 (and/or other optical receivers) operate as a current source. The amplifier U1 (which can comprise a trans-impedance amplifier (TIA)), along with resistor R1, serve to convert the current into a voltage. The value of capacitor C1 can be determined so that it filters out frequencies lower than the pulse and signature frequencies (for example, 100 MHz or lower, 50 MHz or lower, etc.). The output (“SIGNAL”) can then be provided to a signal processing circuit, such as the circuits shown in FIGS. 7A and 7B, and described below.

It can be noted that the basic receiving circuit 600 can be altered in any of a variety of ways, depending on desired functionality. For example, although many LIDAR systems may include a receiver that has only a single photodiode D1 (which can be used, for example, with optics that are configured to steer light received at different angles toward the single photo diode D1), LIDAR systems may additionally or alternatively use an array of photo receivers, any or all of which may include additional circuitry similar to the basic receiving circuit 600. In these cases, the output signals may be combined or multiplexed to provide a single signal to a processing circuit. A person of ordinary skill in the art will appreciate many other alterations are possible, as needed.

FIG. 7A is a block diagram of a processing circuit 700-A, according to one embodiment. Here, the processing circuit 700-A is configured to receive an analog input signal (such as the output signal generated by the basic receiving circuit 600 of FIG. 6). That analog input signal is received by the analog-to-digital converter (ADC 710), which digitizes the signal by converting it into N bits, which are provided to a digital signal processor 720 (DSP) for further processing. In some embodiments, the ADC 710 may be capable of digitizing the relatively high ringing frequencies (e.g., 100 MHz to 1 GHz) that modulate the detected laser pulse received by the LIDAR system.

The DSP 720 can comprise processing circuitry capable of processing an input digital signal and determining whether a laser pulse has been detected, and whether that detected laser pulse has a ringing frequency that corresponds to a ringing frequency of the laser pulse most recently generated by the LIDAR system. It can be noted that some embodiments may utilize circuitry other than or in addition to the DSP 720, capable of analyzing a digital signal as indicated herein. In some embodiments, the DSP 720 may correspond to, be incorporated into, and/or work in conjunction with a processing unit (such as the processing unit 110 of FIG. 1). In some embodiments, the DSP 720 may be implemented by a field-programmable gate array (FPGA) or application-specific integrated circuit (ASIC), which may operate faster and/or more efficiently than other circuitry.

In operation, the DSP 720 has a relatively large amount of time to analyze a signal. In some embodiments, for example, a DSP 720 may only need to analyze a signal every 2 μs or so during normal operation (unless signals from other LIDAR systems are received). As noted previously, when processing an input signal, the DSP 720 can determine whether a pulse has been detected and, if so, determine a ringing frequency (signature) of the pulse. It can then compare the ringing frequency of the pulse with a ringing frequency of the laser pulse most recently generated by the LIDAR system. The DSP 720 may obtain an indication of the ringing frequency of the most recently-generated laser pulse from circuitry (such as a processing unit) that controls the ringing frequency of the generated laser pulses (e.g., circuitry that controls the capacitance of the adjustable capacitor of the driving circuit shown in FIG. 4A or 4B). Alternatively, the DSP 720 itself may control the ringing frequency of the generated laser pulses (e.g., the DSP 720 may correspond with processing unit 110 of FIG. 1, which can control and/or communicate with both the LIDAR transmitter and the LIDAR receiver) and may therefore determine a ringing frequency of the most recently-generated laser pulse (the value of which may be stored in a memory of the DSP 720, for example) and compare it with the determined ringing frequency of the detected laser pulse. If both a pulse and a correct ringing frequency are detected, the DSP 720 can provide a “DETECT” output indicating the detection.

Depending on desired functionality, comparing the frequencies of the most recently-generated laser pulse and the detected laser pulse can be implemented in any of a variety of ways. Because a detected laser pulse may have reflected off an uneven surface, this may distort the ringing frequency of the detected laser pulse, resulting in pulse spreading. As such, the DSP 720 may allow for these distortions by determining whether the ringing frequency of the detected laser pulse is substantially similar to the ringing frequency of the most recently-generated laser pulse, within a certain degree of similarity. In some embodiments, different frequency “bands” may be allocated such that, for purposes of correlating detected laser pulses with generated laser pulses as described herein, ringing frequencies of detected laser pulses that are within a first frequency band are considered to have a first ringing frequency, ringing frequencies of a detected laser pulses that are within a second frequency band are considered to have a second ringing frequency, and so forth.

FIG. 7B is a block diagram of a processing circuit 700-B, according to one embodiment. Because high speed ADCs, like the one utilized in the processing circuit 700-A, may be relatively expensive, the processing circuit 700-B can be utilized as a lower-cost alternative. Here, the processing circuit comprises a comparator 730, a filter 740, and a detector 750. As with all other figures herein, the components illustrated in FIG. 7B are provided as a non-limiting example. Alternative embodiments may employ additional and/or alternative components.

In the processing circuit 700-B, the comparator 730 compares and input signal with a reference signal or voltage (“REF”), outputting a DETECT signal when a pulse is detected. (A person of ordinary skill in the art will readily understand how to determine the value of the reference signal/voltage, depending on desired functionality, manufacturing concerns, and/or other factors.) Unlike the processing circuit 700-A, the DETECT signal here provides an indication of a detected pulse without any indication of whether a ringing frequency of the detected laser pulse matches a ringing frequency of the most recently-generated laser pulse by the LIDAR system. That comparison is separately performed by the filter 740 and detector 750.

To determine whether a ringing frequency of a detected laser pulse is valid (i.e., matches the ringing frequency of the most recently-generated laser pulse), the input signal is also provided to a filter 740. Here, the filter 740 can be a band-pass filter configured to filter out frequencies from the input signal other than the ringing frequency of the most recently-generated laser pulse. In other words, the filter 740 can be a tunable filter tuned to the ringing frequency of the most recently-generated laser pulse. The tuning of the filter 740 may correspond with the adjusting of the ringing frequency by the laser driver circuitry (e.g., an adjustable capacitor as shown in FIG. 4A or 4B). In some embodiments, for example, a single circuit (such as a processing unit) adjusts both the ringing frequency of the generated laser pulse and the tuning of the filter 740. Alternatively, separate circuits driving the ringing frequency of the generated laser pulse and the tuning of the filter 740 may communicate with each other to provide the same functionality. The filter 740 may utilize any of a variety of circuits to provide for its tunability. In some embodiments, the filter 740 may utilize one or more adjustable capacitors, such as the adjustable capacitors shown in FIGS. 4A and 4B. in some embodiments, for example, the filter 740 may comprise a tapped delay line where the signal is sampled at multiple points along the delay line to form a finite impulse response (FIR) filter. In contrast with an ADC and digital filter (which may be expensive and power hungry) a tapped delay line analog FIR may be cheap and not power hungry. In some embodiments, the tapped delay line may comprise transmission line, or a clocked charge coupled device (CCD) analog shift register.

The detector 750 can comprise a circuit configured to determine whether a frequency is detected (e.g., with at least a threshold amplitude) on an output signal of the filter 740. In some embodiments, for example, the detector may measure the amplitude of the input signal after being filtered by the filter 740. If a valid frequency is detected, the detector 750 can produce an output indicating that a detected ringing frequency is valid.

Depending on desired functionality, output signals of processing circuits 700-A and 700-B may vary. In some embodiments, for example, these outputs signals may be binary. In other embodiments, these outputs signals may provide a non-binary score indicating a degree to which a ringing frequency of the detected laser pulse of the LIDAR system matches a ringing frequency of the most recently-generated laser pulse of the LIDAR system. For example, depending on the shape of an object off of which the laser pulse has reflected, a lot of the ringing frequency may get washed away. However, even if weak, a valid ringing frequency of a detected laser pulse suggests that the detected laser pulse corresponds to the most recently-generated laser pulse. A weaker amplitude may result in a lower score. On the other hand, if a pulse is detected but the ringing frequency does not match the ringing frequency of the most recently-generated laser pulse, the pulse likely does not correspond to the most recently-generated laser pulse. A different frequency may result in a (much) lower score.

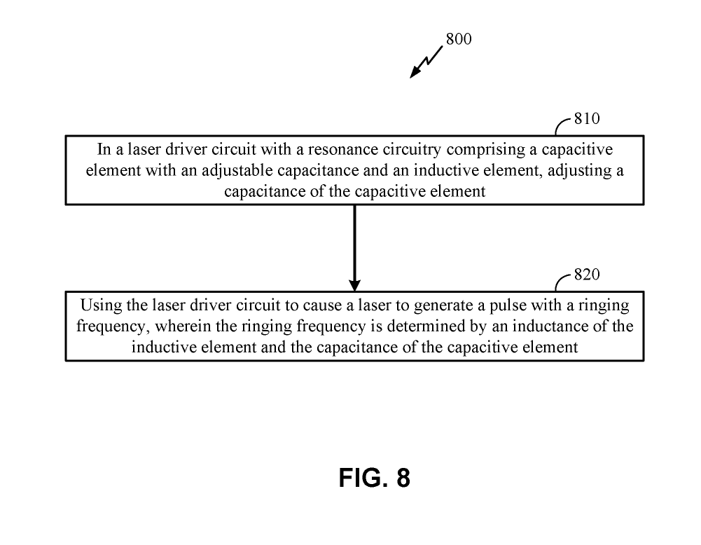

FIG. 8 is a flow diagram of a method 800 of generating laser pulses in a LIDAR system (or other laser ranging device), according to one embodiment. Means for performing the method 800 can include components of the LIDAR system 100 illustrated in FIG. 1, such as a LIDAR transmitter 130 (with a laser 135 and beam-steering optics 133), and LIDAR receiver 120 (with the subcomponents thereof).

The functionality of block 810 comprises, in a laser driver circuit with a resonant circuitry comprising a capacitive element with an adjustable capacitance and an inductive element, adjusting a capacitance of the capacitive element. As indicated previously, laser driver circuits, such as those illustrated in FIGS. 4A and 4B, can include adjustable capacitors whose capacitance may be adjusted to alter the ringing frequency of a generated laser pulse. Adjusting the capacitance of these adjustable capacitors can be done using an input current or voltage. Means for adjusting the capacitance of the adjustable capacitors may include a processing unit (e.g., a DSP) and a DAC. These means may also be utilized to adjust or otherwise control circuitry in the LIDAR receiver to allow the LIDAR receiver to determine whether a ringing frequency of a detected laser pulse is substantially similar to the ringing frequency of a generated laser pulse.

At block 820, the laser driver circuit is used to cause a laser to generate a pulse with a ringing frequency, wherein the ringing frequency is determined by an inductance of the inductive element and the capacitance of the capacitive element. Means for using the laser driver circuit to cause the laser to generate the pulse can also include a processing unit or other circuitry configured to generate a pulse. In FIGS. 4A and 4B, for example, a processing unit and/or other circuitry can be used to provide a pulsed voltage at the gates of transistors U1 and U2 respectively.

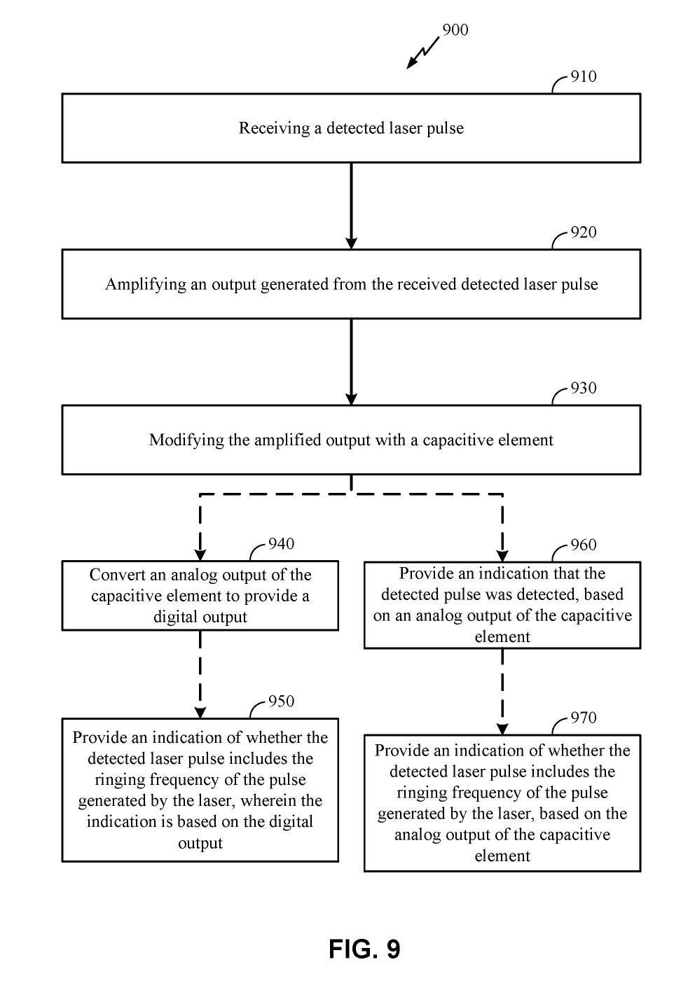

FIG. 9 is a flow diagram of a method 900 of receiving and optionally decoding laser pulses in a LIDAR system (or other laser ranging device), according to one embodiment. Means for performing the method 900 can include components of the LIDAR system 100 illustrated in FIG. 1, such as a LIDAR receiver 120 (with the subcomponents thereof).

The functionality of block 910 comprises, receiving a detected laser pulse. As indicated previously, a LIDAR receiver can include receiving circuit, such as receiving circuit 600 of FIG. 6, with a photodiode to detect a laser pulse (e.g., a laser pulse generated by the LIDAR transmitter and reflected off of an object). As previously noted, embodiments may include photo detectors in addition or as an alternative to a photodiode. Some embodiments, for example, may include an array of photodiodes and/or other photo detectors.

At block 920, an output of the received detected laser pulse is amplified. As indicated in the embodiments described herein above, an output of a photodiode and/or other photo detector can be amplified using, for example, a trans-impedance amplifier and/or other amplification means. Such amplification may serve to convert an output current of the receiving means to a voltage.

At block 930, an amplified output is modified with a capacitive element. In some embodiments, the capacitive element may comprise a single capacitor (as shown in FIG. 6). In other embodiments, the capacitive element may comprise multiple capacitors and/or other elements having electrical capacitance. Here, the capacitive element can act as a high-pass filter that can help filter out noise due to ambient lighting (which has a relatively low frequency compared to high-frequency signals created by the rapidly-changing laser light reflected from the target). A value of the capacitive element can be chosen accordingly.

Optionally, and depending on desired functionality, the method can then either perform the functionality at blocks 940 and 950, or perform the functionality at blocks 960 and 970.

At block 940, an analog output of the capacitive element is converted to provide a digital output. As described herein above with regard to FIG. 7A, this can be done using, for example, a high-speed ADC connected to an output signal of the capacitive element.

At block 950, an indication of whether the detected laser pulse includes the ringing frequency of the pulse generated by the laser is provided, wherein the indication is based on the digital output. This indication can be provided, for example, by a DSP and/or other type of processing circuitry capable of analyzing the digital output provided at block 940 and determining whether the ringing frequency is present. Such circuitry can therefore receive an indication of the ringing frequency of a pulse generated by a laser transmitter circuit (e.g., by a processing unit in communication with both LIDAR transmitter and LIDAR receiver units.

Alternatively, at block 960, the method may instead include providing an indication that the detected pulse was detected, based on an analog output of the capacitive element. As indicated previously with regard to FIG. 7B, this can be done using a comparator that compares the output signal of the capacitive element to a reference signal/voltage.

At block 970, an indication of whether the detected laser pulse includes the ringing frequency of the pulse generated by the laser is provided, based on the analog output of the capacitive element. As noted in the embodiments described herein above, means for performing this functionality can include a filter and/or a detector. Again, the circuitry here may be in communication with a LIDAR transmitter and/or processing unit (that is in communication with the LIDAR transmitter) in order to tune the filter to the ringing frequency of the laser pulse generated by the LIDAR transmitter.

As indicated previously, methods 800 and/or 900 may include any of a variety of additional functions, depending on desired functionality, manufacturing concerns, and/or other factors. For example, a method may additionally include causing control circuitry to adjust the capacitance of the capacitive element to a unique value for each transmitted laser pulse in a series of transmitted laser pulses, such that each transmitted laser pulse has a unique ringing frequency. These adjustments of the capacitive element can be done in the pseudo-random manner. In some embodiments, control circuitry may only adjust the capacitance of the capacitive element in response to receiving an indication that a pulse has been detected that has a substantially similar ringing frequency and was not generated by the LIDAR laser driver circuitry. In some embodiments, the laser driver circuitry can include the inductive element and the capacitive element coupled in series. In some embodiments the laser driver circuitry can include the inductive element and the capacitive element coupled in parallel. In some embodiments, the ringing frequency can comprise a frequency between 100 MHz and 1 GHz. As indicated previously, some embodiments may include processing circuitry that provides an indication (e.g., “score”) of a degree to which a frequency detected in the reflected laser pulse matches the ringing frequency of the pulse generated by the laser.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. Additionally, although the ringing frequency of a laser pulse is used as the sole or primary component of a pulse's signature in the embodiments described herein, alternate embodiments may utilize other aspects or characteristics of a pulse (rise time, fall time, runt pulses, etc.) as all or part of the pulse's signature.

With reference to the appended figures, components that can include memory (such as a processing unit) can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

The various illustrative logical blocks, modules, and circuits described in connection with the aspects disclosed herein may be implemented or performed with a processor, a DSP, an ASIC, an FPGA or other programmable logic device, discrete gate or transistor logic, discrete hardware components, or any combination thereof designed to perform the functions described herein. A processor or processing unit may be a microprocessor, but in the alternative, the processor or processing unit may be any conventional processor, controller, microcontroller, or state machine. A processor or processing unit may also be implemented as a combination of computing devices, e.g., a combination of a DSP and a microprocessor, a plurality of microprocessors, one or more microprocessors in conjunction with a DSP core, or any other such configuration.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A laser ranging device comprising:
a laser; and
resonance components including:
an inductive element, and
a capacitive element having an adjustable capacitance;
wherein the laser ranging device is configured to cause the laser to generate a pulse with a ringing frequency, the ringing frequency determined by an inductance of the inductive element and a capacitance of the capacitive element.

2. The laser ranging device of claim 1, further comprising control circuitry configured to adjust the capacitance of the capacitive element.

3. The laser ranging device of claim 2, wherein the control circuitry is configured to adjust the capacitance of the capacitive element to a unique value for each transmitted laser pulse in a series of transmitted laser pulses, such that each transmitted laser pulse has a unique ringing frequency.

4. The laser ranging device of claim 3, wherein the control circuitry is configured to adjust the capacitance of the capacitive element to a pseudo-random value for each transmitted laser pulse in the series of transmitted laser pulses.

5. The laser ranging device of claim 2, wherein the control circuitry is configured to adjust the capacitance of the capacitive element in response to receiving an indication that a detected pulse has a substantially similar ringing frequency and was not generated by the laser ranging device.

6. The laser ranging device of claim 1, wherein the inductive element and the capacitive element are coupled in series.

7. The laser ranging device of claim 1, wherein the inductive element and the capacitive element are coupled in parallel.

8. The laser ranging device of claim 1, wherein the ringing frequency comprises a frequency between 100 MHz and 1 GHz.

9. The laser ranging device of claim 1, further comprising laser receiver circuitry, the laser receiver circuitry including:
one or more light sensors configured to receive a detected laser pulse;
an amplification circuit coupled to an output of the one or more light sensors; and
a capacitive element coupled to an output of the amplification circuit.

10. The laser ranging device of claim 9, wherein the laser receiver circuitry further includes:
an analog-to-digital converter (ADC) configured to receive an analog signal from the capacitive element and provide a digital output; and
processing circuitry configured to receive the digital output of the ADC and provide an indication of whether the detected laser pulse includes the ringing frequency of the pulse generated by the laser.

11. The laser ranging device of claim 9, wherein the laser receiver circuitry further includes:
a comparator circuit configured to receive an analog signal from the capacitive element provide an indication that the detected laser pulse was detected; and
processing circuitry configured to receive the analog signal from the capacitive element and provide an indication of whether the detected laser pulse includes the ringing frequency of the pulse generated by the laser.

12. The laser ranging device of claim 11, wherein the processing circuitry is configured to provide the indication of whether the detected light pulse includes the ringing frequency by providing an indication of a degree to which a frequency detected in the detected laser pulse matches the ringing frequency of the pulse generated by the laser.

13. A method of generating laser pulses in a laser ranging device, the method comprising:
in a laser driver circuit with resonance circuitry comprising a capacitive element with an adjustable capacitance and an inductive element, adjusting a capacitance of the capacitive element; and
using the laser driver circuit to cause a laser to generate a pulse with a ringing frequency, wherein the ringing frequency is determined by an inductance of the inductive element and the capacitance of the capacitive element.

14. The method of generating laser pulses the laser ranging device of claim 13, further comprising adjusting the capacitance of the capacitive element to a unique value for each transmitted laser pulse in a series of transmitted laser pulses, such that each transmitted laser pulse has a unique ringing frequency.

15. The method of generating laser pulses the laser ranging device of claim 13, further comprising:
receiving a detected laser pulse;
amplifying an output generated from the received detected laser pulse; and
modifying the amplified output with a capacitive element.

16. The method of generating laser pulses the laser ranging device of claim 15, further comprising:
converting an analog output of the capacitive element to provide a digital output; and
providing an indication of whether the detected laser pulse includes the ringing frequency of the pulse generated by the laser, wherein the indication is based on the digital output.

17. An apparatus for generating laser pulses in a laser ranging device, the apparatus comprising:
in a laser driver circuit with resonance circuitry comprising a capacitive element with an adjustable capacitance and an inductive element, means for adjusting a capacitance of the capacitive element; and
means for using the laser driver circuit to cause a laser to generate a pulse with a ringing frequency, wherein the ringing frequency is determined by an inductance of the inductive element and the capacitance of the capacitive element.

18. The apparatus of claim 17, further comprising means for adjusting the capacitance of the capacitive element to a unique value for each transmitted laser pulse in a series of transmitted laser pulses, such that each transmitted laser pulse has a unique ringing frequency.

19. The apparatus of claim 17, further comprising:
means for receiving a detected laser pulse;
means for amplifying an output generated from the received detected laser pulse; and
means for modifying the amplified output with a capacitive element.

20. The apparatus of claim 19, further comprising:
means using a comparator circuit to receive an analog signal from the capacitive element and provide an indication that the detected laser pulse was detected; and
means for providing an indication of whether the detected laser pulse includes the ringing frequency of the pulse generated by the laser.
